(19) United States
(12) Patent Application Publication
(10) Pub. No.: US 2005/0000378 A1
(43) Pub. Date: Jan. 6, 2005

(54) Method for color separation

(76) Inventor: Bruno Zurcher, Kusnacht (CH)

Correspondence Address: LADAS & PARRY, 26 WEST 61ST STREET, NEW YORK, NY, 10023, US

(21) Appl. No.: 10/276,077

(22) PCT Filed: Apr. 3, 2001
(86) PCT No.: PCT/IB01/00547

(30) Foreign Application Priority Data
Mar. 13, 2000 (EP) 00110318.3

(51) Int. Cl. B41C 1/00

(52) U.S. Cl. 101/483

(57) ABSTRACT

The invention relates to a system for dividing a color image in at least three, preferably four separation colors. The inventive system allows to enter the separation colors in a free and location dependent manner. Further for each separation color a location dependent boundary value can be specified. Corresponding separation values are deduced therefrom. In addition, variations of the generated image relatively to the color image are calculated. This allows to perform a color separation into arbitrary colors, which is particularly useful in the field of security printing.

### REFERENCE TO RELATED APPLICATIONS

This application claims the priority of the European patent application 00110318.3, filed May 13, 2000, the disclosure of which is incorporated herein by reference in its entirety.

### BACKGROUND ART

The invention relates to a method and a computer program for color separation according to the preamble of the independent claims.

### STATE OF THE ART

Methods or programs of this kind serve as a pre-stage to the printing process. They allow to divide a color image into printing colors, i.e. separation colors. Normally thereby a color image in the RGB-space is divided into its CMYK-components for then being printed with corresponding colors, i.e. Cyan, Magenta, Yellow and Black. However, existing solutions are only conditionally suitable for security and specialty printing, where other kinds of colors are applied.

### DESCRIPTION OF THE INVENTION

A problem to be solved by the present invention lies therefore in providing a computer program or a method of the kind mentioned at the outset that-allows a flexible color separation. This problem is solved by the subject of the independent claims.

According to the invention it is thus possible to specify at least one, preferably all of the separation colors variably, i.e. the user can specify the desired color value for this/these separation color(s), e.g. in form of their RGB-components, and is not bound to a predefined value. Moreover he enters a color image. Than it is calculated how the color image is to be represented best in the desired separation colors. For this the corresponding separation values are determined. These indicate the degree of coverage or the color quantity for the particular separation color.

Preferably at least one of the separation colors can be specified location dependently. This allows to generate color separations for printing processes where the individual separation colors change depending on the location, which in particular is applicable in security printing. For this, the separation color can e.g. be specified for each image pixel separately. For example the separation color can be specified as a two dimensional arrangement of different color pixels.

It is also possible to specify for at least one of the separation colors a location dependent range mask. Such a mask can impose an upper or a lower limit to the component of the separation color, which e.g. allows to limit the maximum coverage or to achieve security engineering effects.

The resulting picture is preferably calculated according to the color components of the separation colors. From the resulting image the deviation to the color image can then be determined, which allows an examination of the quality of the color separation. In particular for this purpose this deviation can be represented location dependently, e.g. by comparing it with a boundary value and marking those areas where the deviation is bigger than the boundary value.

For the implementation of the method a computer program can be provided, wherein this is to be understood to be an entire application executable under a suitable operating system or a plug-in, i.e. a module, for such an application. Such a program must be able to read a user defined color value for at least one of the separation colors.

A design as a plug-in for an image processing program, which provides several image layers for two dimensional pixel data, is preferred. In such an environment the input and output data can be provided in a simple way. In particular the color image can be retrievable in one of the image layers. Also the separation colors can be saved location dependently in image layers. As output, the color components can be saved in layer masks, wherein the separation colors are saved in the respective image layers. This allows, in a simple way to generate data for the printing process and/or to visualize the components and effects of the individual separation colors.

### SHORT DESCRIPTION OF THE DRAWINGS

Further embodiments, advantages and applications of the invention are described in the dependent claims as well as in the following description, which makes reference to the enclosed figures. These figures show:

FIG. 1 an implementation of the method according to the invention and

FIG. 2 a flow diagram at the execution of a program.

### MODES FOR CARRYING OUT THE INVENTION

The method or the computer program according to the present invention starts from a color image C_{T}, which is e.g. given as an arrangement of image pixels in a color space. Normally this is a three dimensional color space, such as the RGB-space or an other CIE-XYZ space.

Preferably four (possibly also only three or more than four) separation colors C₁, C₂, C₃ and C₄ are given, and, where applicable, one background color C₀. The separation colors C₁, C₂, C₃ and C₄ correspond to the printing colors, in which the given color image is to be printed.

In particular in security printing it is possible that the separation colors are location dependent, i.e. that they have different values for different image pixels.

During printing, the separations colors C₁, C₂, C₃ and C₄ are applied according to their so called separation values α₁, α₂, α₃, and α₄ (half tone method), such that an optically recognizable color C(α₁, α₂, α₃, α₄) results. The separation values describe how intensely each separation color is to be employed.

To be found are those separation values α₁, α₂, α₃, and α₄ that result in a as realistic as possible representation of the color image C_{T}. Under “as realistic as possible” for a color C_{T}, the particular printing color C is to be understood for which e.g. |C_{T}−C|² (or a different, suitable measure) is minimal.

In the appendix a method is described how, for a given color C_{T} and for given separation colors C₁, C₂, C₃ and C₄, suitable separation values α₁, α₂, α₃ and α₄ can be found for obtaining a representation C of the color C_{T} that is as realistic as possible.

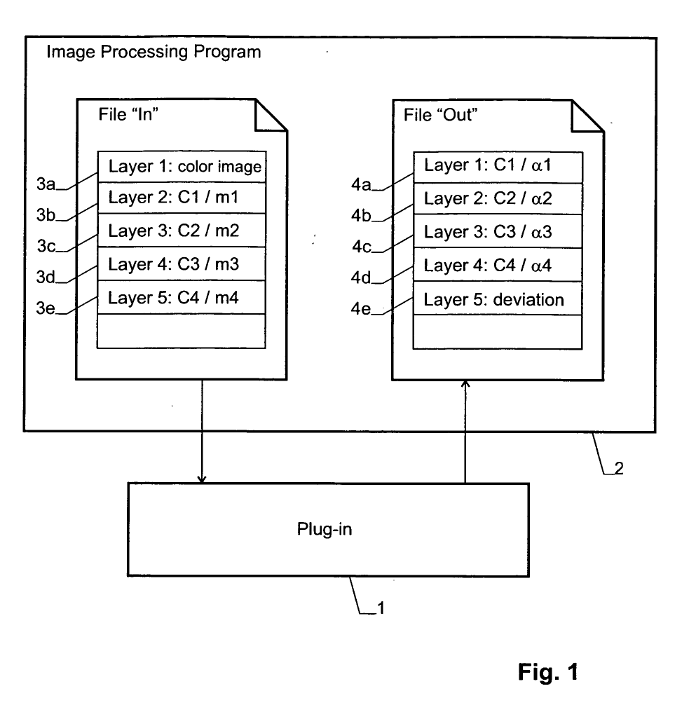

A specific implementation of the method in the form of a plug-in 1 for an image processing program 2 is represented in FIG. 1. The image processing program 2 may be e.g. the product “Photoshop” of the firm Adobe Systems Incorporated. Such image processing programs allow to integrate extensions as so called “Plug-ins”. These techniques are known to persons skilled in the art.

The program code of the plug-in 1 performs, when it is called, the steps described in the following.

When the plug-in is executed, it firstly asks the user for the input parameters. Then it accesses a file “In” for determining the color image and the separation colors. It then calculates the separation values α₁, α₂, α₃ and α₄ and saves them in a file “Out”.

Both files are managed and displayed by the image processing program 2. Each file has several image layers 3a-3e or 4a-4e. Each image layer saves pixel data as well as a layer mask. The pixel data are a two dimensional array of color values, e.g. in RGB-format. The layer mask is a two dimensional array of the same size of mask values, wherein each mask value e.g. is a number between 0 and 255.

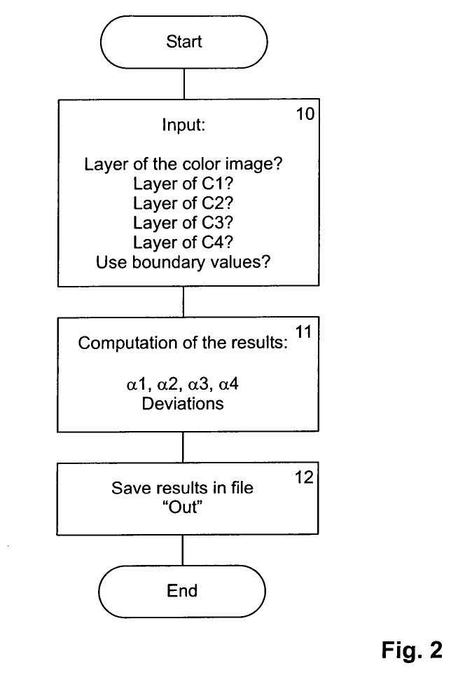

The flow during execution of the plug-in 2 is shown in FIG. 2:

In a first step 10 the user is asked for input parameters. For this he specifies four different image layers of the file “In”.

The layer of the color image to be separated:

In this layer the color image for which a color separation is to be performed is stored.

Four layers for the separation colors C₁, C₂, C₃ and C₄: In the pixel data of these layers the particular separation color is stored. This allows the user, using the tools of the image processing program 2, to define each separation variably and individually. He is not bound to predefined separation colors. Each separation color can also be location dependent, i.e. in a left part of the image, e.g. different RGB-values can be used for the separation color than in a right part of the image. Moreover, in the layer mask of each of these layers a range mask can be saved. This indicates, for each pixel of the separation color Cᵢ, a boundary value for the separation value α₁, for example an upper boundary value.

Use of the boundary values: Here the user can indicate if the boundary values saved in the layer masks of the layers of C₁, C₂, C₃, C₄ are to be taken into account.

In step 11 the results are calculated. These are the separation values α₁, α₂, α₃ and α₄ and there deviation C_{T}−C. This is done pixel by pixel. For each pixel of the color image the separation colors C₁, C₂, C₃, C₄ from the respective layers 3b-3e are loaded, as well as, where applicable, the respective boundary values. Then the separation values α₁, α₂, α₃ and α₄ for the respective pixel are calculated, e.g. with the algorithm indicated in the appendix.

In step 12 these results are saved in the file “Out”, wherein this is created if necessary. The file “Out” contains the layers 4a, 4b, 4c, 4d, whose pixel data correspond to those of the layers 3b, 3c, 3d, 3e of the file “In”, i.e. contain the separation colors C₁, C₂, C₃, C₄. The layer masks of these layers contain the separation values α₁, α₂, α₃ and α₄. Finally in a layer 4e of the file “Out” the deviation is saved.

The resulting image C is determined computationally from the values of the Cₖ and αₖ, namely from:

$$C = 255 \cdot {\prod }_{k = 1}^{4} ( 1 - {α}_{k} \cdot ( 1 - {C}_{k} / 255 ) )$$

The level 4e of the file “out”, which indicates the deviation C_{T}−C, can, as pixel data, e.g. contain the color image from level 3a of the file “In”, and namely for all those pixels where the deviation |C_{T}−C| is above a predefined boundary value. The other pixels are white or transparent. In the layer mask of layer 4e the deviation |C_{T}−C| scaled from 0 to 255 for the respective pixel is saved.

This allows to represent the deviation, and in particular the ranges of the color image with large deviation, location dependently. They can also be blended over the resulting image.

The possibility to indicate a boundary value for each separation color allows, e.g., to use two colors that are substantially identical, but have different optical properties in other spectral ranges, e.g. a different fluorescence at UV-irradiation. In a region where the first of the two colors is to be used, the upper boundary value of the second color is set to 0 and vice versa.

It is also thinkable to specify more than four separation colors. In this case too, with the methods indicated in the appendix, respective separation values αₖ can be determined. On the other hand, only three separation colors can be used, which, however, can result in losses in the image quality.

In the example above the method according to the invention is implemented as a plug-in for an image processing program. It is also possible to implement the method as a stand alone application with its own user interface, which loads and saves its data directly using the particular operating system.

Appendix:

If a picture is printed in four separation colors C₁, C₂, C₃, C₄ on a background with color C₀ with four half tone rasters, 16 different colors can result. These are:
C₀: background color
C₁: fundamental color 1
C₂: fundamental color 2
C₃: fundamental color 3
C₄: fundamental color 4
C₁₂: combination of C₁ and C₂
C₁₃: combination of C₁ and C₃
C₁₄: combination of C₁ and C₄
C₂₃: combination of C₂ and C₃
C₂₄: combination of C₂ and C₄
C₃₄: combination of C₃ and C₄
C₁₂₃: combination of C₁, C₂ and C₃
C₁₂₄: combination of C₁, C₂ and C₄
C₂₃₄: combination of C₂, C₃ and C₄
C₁₂₃₄: combination of C₁, C₂, C₃ and C₄

For the calculation of the separation values the above mentioned color combinations are identified by their tristimulus-values in a 3D-color space (e.g. RGB or CIE-XYZ space), i.e. it is C*∈IR³.

The Neugebauer-equation now models the resulting color C as a linear function of the color C* and its respective spatial components a*.

$$C = {a}_{0} {C}_{0} + {a}_{1} {C}_{1} + {a}_{2} {C}_{2} + {a}_{3} {C}_{3} + {a}_{4} {C}_{4} + {a}_{12} {C}_{12} + {a}_{13} {C}_{13} + {a}_{14} {C}_{14} + {a}_{23} {C}_{23} + {a}_{24} {C}_{24} + {a}_{34} {C}_{34} + {a}_{123} {C}_{123} + {a}_{124} {C}_{124} + {a}_{134} {C}_{134} + {a}_{234} {C}_{234} + {a}_{1234} {C}_{1234}$$

If one assumes that the coefficients a* behave according to the overlapping model of Demichel, i.e. that they can be expressed as a function of half tone intensities or separation values α₁, α₂, α₃ and α₄ (independent rasters), the Neugebauer-Equation is written as C: IR⁴→IR³, or written in detail:

$$C ( {α}_{1} , {α}_{2} , {α}_{3} , {α}_{4} ) = ( 1 - {α}_{1} ) ( 1 - {α}_{2} ) ( 1 - {α}_{3} ) ( 1 - {α}_{4} ) {C}_{0} + {α}_{1} ( 1 - {α}_{2} ) ( 1 - {α}_{3} ) ( 1 - {α}_{4} ) {C}_{1} + ( 1 - {α}_{1} ) {α}_{2} ( 1 - {α}_{3} ) ( 1 - {α}_{4} ) {C}_{2} + ( 1 - {α}_{1} ) ( 1 - {α}_{2} ) {α}_{3} ( 1 - {α}_{4} ) {C}_{3} + ( 1 - {α}_{1} ) ( 1 - {α}_{2} ) ( 1 - {α}_{3} ) {α}_{4} {C}_{4} + {α}_{1} {α}_{2} ( 1 - {α}_{3} ) ( 1 - {α}_{4} ) {C}_{12} + {α}_{1} ( 1 - {α}_{2} ) {α}_{3} ( 1 - {α}_{4} ) {C}_{13} + {α}_{1} ( 1 - {α}_{2} ) ( 1 - {α}_{3} ) {α}_{4} {C}_{14} + ( 1 - {α}_{1} ) {α}_{2} {α}_{3} ( 1 - {α}_{4} ) {C}_{23} + ( 1 - {α}_{1} ) {α}_{2} ( 1 - {α}_{3} ) {α}_{4} {C}_{24} + ( 1 - {α}_{1} ) ( 1 - {α}_{2} ) {α}_{3} {α}_{4} {C}_{34} + {α}_{1} {α}_{2} {α}_{3} ( 1 - {α}_{4} ) {C}_{123} + {α}_{1} {α}_{2} ( 1 - {α}_{3} ) {α}_{4} {C}_{124} + {α}_{1} ( 1 - {α}_{2} ) {α}_{3} {α}_{4} {C}_{134} + ( 1 - {α}_{1} ) {α}_{2} {α}_{3} {α}_{4} {C}_{234} + {α}_{1} {α}_{2} {α}_{3} {α}_{4} {C}_{1234}$$

For a given color C_{T} the calculation of the separation values α₁, α₂, α₃ and α₄ in respect to the separation colors C₁, C₂, C₃, C₄ results by inverting the equation system
C(α₁, α₂, α₃, α₄)=C_{T} (1)

This equation system with three equations and 4 unknowns is under-determined and there exist in general infinitely many solutions. For unique solvability, a limitation
g(α)=∥−p∥² minimal (2)
is introduced, wherein α=(α₁, α₂, α₃, α₄) and p∈IR⁴ can be chosen arbitrarily, e.g. p=0.

The problem can now be regarded as an extremal value problem (2) with boundary conditions (1). The corresponding Lagrange's principal function Φ: IR⁷→IR is
Φ(α, λ)=g(α)+ [symbol] λ, C(α)−C_{T} [symbol] ,
wherein λ∈IR³ and [symbol] .,. [symbol] designates the scalar product in IR³. The corresponding theorem of Lagrange says that the solutions of the equation system
∇(α, λ)=0 (3)
coincide with the solutions of systems (1) and (2). Here ∇ designates the gradient in respect to α and λ. The equation system (3) consist of 7 unknowns and 7 equations and can be solved with standard methods as they are known from numerics.

If the equation (1) cannot be solved, the deviation |C(α₁, α₂, α₃, α₄)−C_{T}| is minimized.

This formalism can also be generalized for calculations with more than four separation colors. For getting unique solutions, further boundary conditions of the kind of formula (2) can be provided if necessary.

The formalism above is based on the assumption that the printing rasters are independent for the particular separation colors. If the rasters are not independent from each other, the calculation of C(α₁, α₂, α₃, α₄) is to be adapted accordingly. In general the present method is suitable for the use with arbitrary rasters, also non standard rasters.

### REFERENCES

[1] H. E. J. Neugebauer, “Die theoretischen Grundlagen des Mehrfarbendruckes”, Zeitschrift für wissenschaftliche Photographie, Photophysik und Photochemie 36, p. 73-89 (1937).
[2] E. Demichel, Procede 26, p. 17-21, p. 26-27 (1924).
[3] H. R. Kang, “Color Technology for Electronic Imaging Devices”, SPIE Optical Engineering Press (1997).
[4] K. J. Heuberger, Z. M. Jing, “Farbtransformation von RGB zu CMY”, UGRA Bericht 105/1, St. Gallen 1991.
[5] H. Heuser, “Lehrbuch der Analysis”, B. G. Teubner Stuttgart.
[6] W. H. Press, B. P. Flannery, S. A. Teukolsky, W. T. Vetterling, “Numerical Recipes”, Cambridge University Press (1992).

While in the present application preferred embodiments of the invention are described, it is to be clearly pointed out, that the invention is not limited to these and can be embodied also in a different way within the scope of the following claims.

1. Method for color separation of a color image into at least three, preferably four, separation colors comprising the steps of
inputting the color image,
inputting in user-selectable manner at least one of the separation colors, and
calculating separation values of the separation colors such that the separation colors printed according to the separation values substantially result in the color image.

2. Method of claim 1, wherein all separation colors are inputted arbitrarily.

3. Method of claim 1, wherein at least one of the separation colors is location dependent and the separation colors are calculated location dependently.

4. Method of claim 3, wherein the color image (C_{T}) consists of a two dimensional arrangement of image pixels, and that at least one of the separation colors is specified location dependently for each image pixel individually.

5. Method of claim 3, wherein at least one of the separation colors is specified as a two dimensional arrangement of separation color pixels.

6. Method of claim 1, wherein for at least one of the separation colors a location dependent range mask is specified, which imposes an upper and/or a lower limit to the separation value of the separation color.

7. Method of claim 6, wherein two of the separation colors are the same in the visible spectral range but have different optical properties in other spectral ranges, and that, by means of the location dependent range mask, in different areas one of the separation colors that are the same in the visual range is suppressed.

8. Method of claim 1, wherein according to the separation values a resulting image and a deviation of the resulting image from the color image is calculated.

9. Method of claim 8, wherein the deviation is displayed location dependently.

10. (cancelled)

11. Computer program product of claim 17, wherein it is designed for reading in the first separation color as two dimensional arrangement of separation color pixels.

12. Computer program product of 17, wherein it is a plug-in for an image processing program providing several image layers for two-dimensional pixel data, wherein with the plug-in the color image can be read out from a first image layer.

13. Computer program product of claim 12, wherein it is designed for reading out at least one of the separation colors location dependently from a second of the image layers.

14. Computer program product of any of the claim 13, characterized in that, wherein for each image layer, a location dependent layer mask is assigned, and that the program is designed for saving the separation values a in layer masks, wherein the separation colors are saved in the corresponding image layers.

15. Method of claim 4, wherein all separation colors are specified location dependently for each image pixel individually.

16. Method of claim 5, wherein all separation colors are specified as a two dimensional arrangement of separation color pixels.

17. Computer program product for color separation of a color image into at least three, preferably four, separation colors comprising
program code means for inputting the color image,
program code means for inputting in user-selectable manner at least a first one of the separation colors,
program code means for calculating separation values of the separation colors such that the separation colors printed according to the separation values substantially result in the color image.
